(19) United States
(12) Patent Application Publication
(10) Pub. No.: US 2009/0007011 A1
(43) Pub. Date: Jan. 1, 2009

(54) SEMANTICALLY RICH WAY OF NAVIGATING ON A USER DEVICE

(75) Inventors: Mary P. Czerwinski, Woodinville, WA (US); Anoop Gupta, Woodinville, WA (US); Bruce Johnson, Woodinville, WA (US); Richard J. McAniff, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/770,645

(22) Filed: Jun. 28, 2007

(51) Int. Cl. G06F 3/048; G06F 15/00

(52) U.S. Cl. 715/810; 715/853

(57) ABSTRACT

Information can be presented to a user as high-level content that is dynamically presented to a user based on a request, a user role, extrinsic information and so forth. As the user navigates the high level content, lower level information that was masked can be selectively revealed or exposed. Upon request, the user can be automatically transitioned back to the high level content. Different versions of a document can be maintained within a master document and, upon request, one of the versions can be displayed as a function of a rendering device.

### BACKGROUND

Wireless mobile technology has become widespread and is utilized for both personal as well as business uses. Mobile devices such as telephones, pagers, personal digital assistants (PDAs), data terminals, etc. are designed to be carried by those who travel from place to place in the daily course of business, for personal reasons, or both business and personal reasons. It is also becoming more common for users of mobile devices to utilize such devices in place of conventional wired systems. If fact, many users rely solely on mobile devices to communicate information and no longer have a traditional wired computing system.

The appeal of mobile devices is due in large part to the convenience of having such devices available regardless of where the user may be located (e.g., at home, at work, traveling, out of town, and so on). In such a manner, users can easily stay “connected”. Such computing devices can be accessed at almost any time and any place and can contain a tremendous amount of information relating to people, organizations, general interests, etc. Electronic storage mechanisms have enabled accumulation of massive amounts of data. For instance, data that previously required volumes of books for recordation can now be stored electronically without the expense of printing paper and with a fraction of the physical space needed for storage of paper.

However, many mobile devices have small display areas that do not provide a large amount of space for data to be displayed. Since it is difficult for large amounts of data to be presented at the same time, lists have been developed to enable a user to select a desired content. However, such lists are becoming quite long and cumbersome to navigate. Thus, the appeal of mobile devices can also be a hindrance due to device limitations.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with rendering display data on a mobile device to allow a user to easily glance at the device and perceive the displayed content. The information (e.g., communications files, applications) can be integrated on the device or retrieved from an external source. When information is requested (e.g., verbally, manually, and so forth), the information can be selectively presented based on a role-based function. A symmetrically rich group of metadata can be exposed, allowing a user to drill down into an information space of concern. The metadata can be information about people, meetings, messages, and so forth that can be relevant to the user. The user can perform a function (e.g., verbal or manual command) to zoom down into the information and, likewise, easily return to a top or high-level overview. In accordance with some aspects, information can be selectively presented as a function of the rendering device.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates an example system that facilitates navigation on a user device.

FIG. 2 illustrates an example system for dynamically presenting data based in part on a user role.

FIG. 3 illustrates an example system that can provide a semantically rich way of navigating on a user device.

FIG. 4 illustrates a system for providing multiple versions of a document and presenting one of the versions based on a rendering device.

FIG. 5 illustrates an example system that employs machine learning to automate one or more of the disclosed features.

FIG. 6 illustrates a method for providing navigation of display data on a user device.

FIG. 7 illustrates a method for selectively presenting a subset of data to a user.

FIG. 8 illustrates a method for dynamically displaying a version of a document as a function of a rendering device.

FIG. 9 illustrates a block diagram of a computer operable to execute the disclosed aspects.

FIG. 10 illustrates a schematic block diagram of an exemplary computing environment operable to execute the disclosed aspects.

### DETAILED DESCRIPTION

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

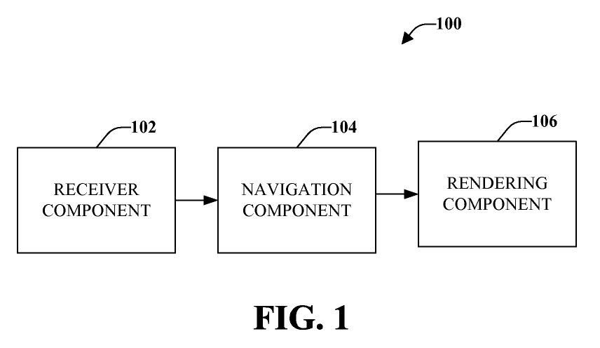

Referring initially to FIG. 1, illustrated is an example system 100 that facilitates navigation on a user device. Some mobile devices have small display areas that do not allow presentation of a large amount of data at a similar time. In addition, an individual might only desire to obtain a subset of available data due to time constraints, interests, a role being performed, or other factors. System 100 can provide a user with a semantically rich way of navigating on a device so that desired content can be output while unrelated or undesired content can be masked from view.

System 100 can present the data in a non-linear format that provides a multitude of options for “zooming” into or out of the data, as opposed to linear lists representing data that can be viewed. System 100 can present the content as a map of what the user might desire to view and can allow the user to drill down into different areas. The map can expose metadata that can be relevant to the user and which can be dynamically structured, allowing the content to change over time.

A receiver component 102 can be configured to receive a request from a user for various content. Receiver component 102 might also receive or seek information relating to extrinsic evidence that can be relevant to the information presented to the user (e.g., location of the user, role in which the user is currently performing and so forth). In accordance with some aspects, receiver component 102 can receive inputs that are in different formats or multi-modal. For example, a combination of gestures, speech recognition and/or manual inputs (e.g., pressing a button or touching a screen of the device) can be accepted by receiver component 102 at substantially the same time. Receiver component 102 can parse or break down the various inputs into subcomponents that can be presented to the user according to a hierarchical scheme (e.g., high-level data initially provided and user systematically requests lower level content). In accordance with some aspects, verification or other means for confirming a returned result matches a user request can be solicited by system 100.

Also included in system 100 is a navigation component 104 that can facilitate routing or directing the user from a high-level overview of the content to more detailed content (e.g., full information). The content can be presented as a series of “bubbles” or icons that relate to the most common features sought after by the user and/or what a user might like to receive. The content can be presented visibly or audibly, depending on a format desired by the user. A determination of which features to present can be based on historical data, user inputs, or other information learned and/or inferred by system 100. In accordance with some aspects, the user can be presented with metadata that “pops-up” or is dynamically presented as the user interfaces with the device or as the device is moved from one location to another location.

Navigation component 104 can be configured to dynamically provide a user with more or less content as the user reviews at least a portion of information presented by a rendering component 106. At substantially the same time as receiving a request, navigation component 104 can transition from the high-level overview to the full details or from the full details to the high-level overview. For example, a user might review a high-level overview of content and desire to drill down or zoom in to view more content relating to a subset of the information. Navigation component 104 can receive a command to perform a related function, such as voice command or through another interaction with user device. As navigation component 104 receives the command, more information can be presented to the user based on a screen size and the amount of data to be viewed. If the user requests less information, navigation component 104 can dynamically present the user with the high-level overview of the content, allowing the user to obtain a different subset of the information or view other information that can be retrieved or obtained.

The information can be retrieved from an information database or another medium that includes the desired information or content. The content can be retrieved from the information database based on a user request or the content can be retrieved based on a system 100 inference of what the user might want to view, which can be based on historical data, incoming communications (e.g., email, instant message) and so forth.

For example, navigation component 104 can present the user with a series of tasks or features (e.g., open a file, make a phone call, search for local areas of interest and so forth). A user might implement some of the tasks but one or more tasks might not be employed and/or might only be employed occasionally. Navigation component 104 can modify the tasks or features it presents based on knowledge of how the user manipulates the device. As such, the features most relevant to the user can be presented on the display area at substantially the same time, mitigating the need for scrolling or moving a display page “up” and “down”.

The content can include frequently accessed documents, frequently accessed applications, status of identified people, places of interest, meetings, incoming communications, and so forth. Content can also include information requested by the user. In accordance with some aspects, content can be provided based on location as determined by a Global Positioning System (GPS) or other location tracking means. For example, if a user is traveling around a city and it is near dinnertime, a listing of restaurants or other places of interest can be dynamically presented, further mitigating the need to search the device for relevant content.

In accordance with some aspects, navigate component 104 can be configured to render content based on a user role at the time the information is requested and/or presented. At any time, a user can be performing one or more roles, depending on the circumstances. A first role can be the user's role as a person or individual. This role can include a work role, a home role, a friend role, a family role and so forth. Another type of role is one that can be divided among different people, such as a shift supervisor, wherein each shift has a different person operating as the supervisor. Thus, in the case of the shift supervisor there can be three or more people that alternate role responsibilities. Information intended for the shift supervisor (e.g., safety procedures, changes in shift duties, and so forth) is not dependent on the actual person that is performing the role at any particular time.

A rendering component 106 can be configured to present subsets of content that can be displayed as a function of a size of the device display area. If the content is to be presented audibly, rendering component 106, can present the content based on user requirements (e.g., time-based, interest based and so on).

In accordance with some aspects, a creator of a file (e.g., document, spreadsheet and so forth) or another user and/or entity can partition a file into subsets of data or can provide a scaled down version of content (e.g., multiple versions of a file). Subsets of data and/or a scaled down version can allow relevant data to be presented as a function of a display area of the rendering device. When rendering component 106 presents the information, various subsets or a particular version of the file can be displayed. If the user would like to view content that might be masked because it is lower in a hierarchy, navigation component 104 can provide a simple means for drilling down into the lower-levels of content. When the user is finished reviewing the content, a single button or voice-command can instruct navigate component 104 to dynamically return to the high-level overview, which can be output to the user by rendering component 106.

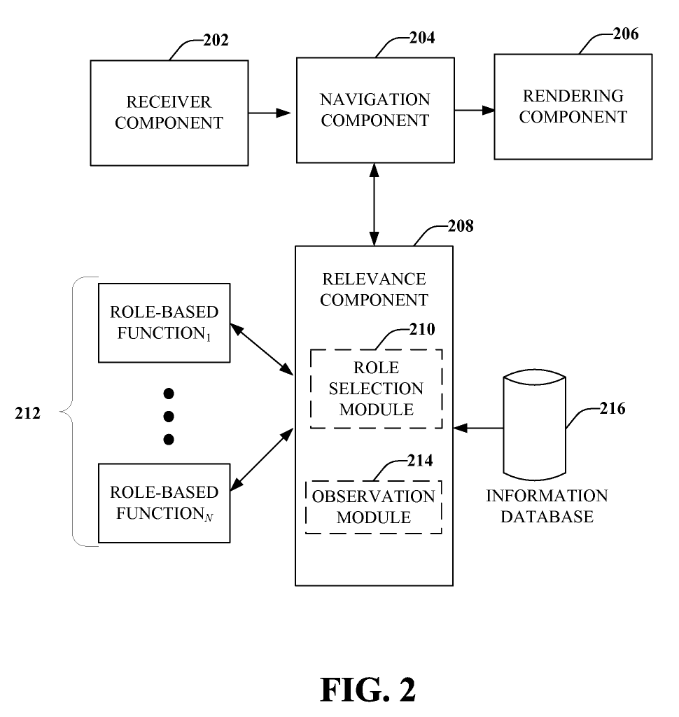

FIG. 2 illustrates an example system 200 for dynamically presenting data based in part on a user role. Some communications are intended for a named recipient regardless of the role the person is performing at the time the communication is received. For example, a son can send a communication to his mother, based on her parent role; a wife can send an email to her husband, based on his spouse role and so forth. Other communications can be intended for a role, not the person performing the role (e.g., a machinist in a shop that operates twenty-four hours a day, seven days a week). Thus, each role can be unique to the individual or can be applied to one or more individuals performing the role.

System 200 can include a receiver component 202 that can receive an incoming communication and a navigation component 204 that can determine whether a communication or other information is intended for a current role of the user and/or whether the content should be presented to the user. If the communication is intended for a user, a rendering component 206 can be configured to dynamically present the communication to the user. If the content is not intended for the user, it can be selectively masked.

In further detail, navigate component 204 can be associated with, or can include, a relevance component 208 that can be configured to analyze content and determine a significance of the content to the user. Relevance component 208 can include a role selection module 210 that can be configured to allow a user to select one or more roles in which the user is currently functioning. As illustrated, a user can be performing 1 to N roles, where N is an integer. Roles 1 to N can be referred to individually or collectively as roles 212 and can change periodically as the user performs different tasks or at different times of the day.

Based on the user role 212, navigation component 204 can selectively allow content or communications to be presented to the user by rendering component 206. If the content is not intended for the user based on the role, the content can be masked or not presented to the user. For example, if a shift supervisor if no longer at work, the role as shift supervisor is complete for the day. The user might no longer be concerned with communications or other data intended for the shift supervisor role, which is now being carried out by another user. Thus, navigation component 204 can mask content intended for the shift supervisor role (e.g., addressed to that role) and not bother the user with the information.

Relevance component 210 can also include an observation module 214 that can be configured to determine a user role based on a current time. A user might forget to change a role at the end or beginning of a work shift or at other times of the day. In some situations, a user might not be aware that a different role has been transitioned into. Thus, observation module 214 can infer that at certain times of the day a user is performing a particular role.

In accordance with some aspects, observation module 214 can infer a role based on extrinsic evidence (e.g., activities being performed), which can be collected by receiver component 202. Extrinsic evidence can include whether a user is viewing a social network and a particular blog or other web page associated with a particular individual, wherein the viewing of that page can include information about the user role. For example, if a father is viewing his daughter's webpage, observation module 214 can infer that the user (father) is assuming a parenting role. The information relating to the activity can be pre-established. For example, if the user is viewing a social network repository and/or a personal email account, it can automatically indicate a home role. On the other hand, if the user is viewing a work related website, it can indicate a work role.

In addition to communications, various databases or repositories, such as information database 216, can contain data that can be selectively exposed or masked depending upon the user role or other user related information (e.g., location of the user, most commonly used tasks, and so forth). Thus, navigation component 204 can filter various content by exposing or masking repositories as a function of the user role. By masking data in the information database 216 that might not of interest to a user, navigation component 204 can provide less irrelevant content on a display screen, thus, allowing space for more relevant content to be displayed.

Information database 216 can include memory and/or some other medium that can store information. By way of example, and not limitation, information database can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

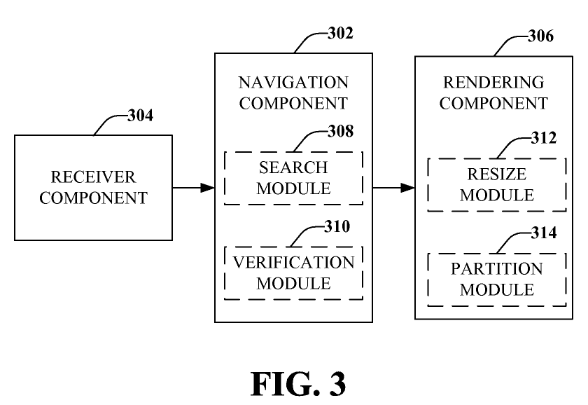

With reference now to FIG. 3, illustrated is an example system 300 that can provide a semantically rich way of navigating on a user device. At times, a user might be busy performing a task but still needs to obtain information, make a phone call or perform other functions that can be dynamically performed by system 300. For example, a father is in a vehicle and needs to call a babysitter or day-care center to let responsible people know that he will be late due to the traffic. System 300 allows the father to make the call without having to handle the device or even look at the device.

System 300 is similar to the above figures and includes a receiver component 302 that can be configured to receive various inputs, including multi-modal inputs. The inputs can be received individually or multiple inputs can be received at substantially a same time. A navigation component 304 can be configured to navigate various portions of a device and/or facilitate a user navigation on the device, which might have a small display area. As inputs are received, navigation component 304 can access various subsections of documents or other items in order to dynamically obtain data that is relevant to the user, which can be output through rendering component 306.

Navigation component 304 can include a search module 308 that can be configured to automatically perform a search to obtain various data based on a user request. The search can be performed either internally on the device or externally. The search can include obtaining data for review by the user and/or for system 300 to autonomously perform a function. For example, a user can request that a phone call be made to “Ann” or “home” or “work”. The request can be made in a multitude of ways including a text input, an audio input or other inputs (e.g., selecting an icon or other element on a display screen). Search component 102 can be configured to begin a search based on the received request.

As information is discovered, it might be determined that more than one document or item is found corresponding the received request (e.g., there are three people listed as Ann in a device telephone directory). A verification module 310 can be configured to confirm whether content discovered is the content requested by the user and/or obtain further information, if necessary. Verification module 310 can present the user with alternatives (e.g., “There are three Mary's, which one is correct?” or “There are three phone numbers for Mary, work, home and cell, which one can she be reached at?”) based on the information retrieved. In accordance with some aspects, verification module 310 can present the found results and interact with the user to determine if a broader search should be conducted (e.g., external to the device) and/or if other actions should be performed (e.g., narrow the search).

Based on the results of the search, a rendering component 306 can dynamically present the results to the user, which can be in the form of displaying information relating to the search and/or autonomously performing an action associated with the search (e.g., calling Mary). In accordance with some aspects, at least a subset of the content can presented to the user by rendering component 306.

Various information can be utilized by rendering component 306 in order to present information that allows a user to easily glance at a small screen and view meaningful information. In accordance with some aspects, rendering component 306 includes a resize module 312 and/or a partition module 314 that can be configured to reconfigured content based on a screen size and/or render individual subsets of content on subdivisions of a display area. For example, if a small amount of data is to be display, resize module 312 can increase the size of the text or a picture associated with content so that the content is presented in a manner that is easy to see when the user glances at the device. If there are multiple types of data to display (e.g., different portions of a single document, multiple files, and so forth), partition module 314 can divide a screen into two or more areas, depending on the amount of data that will be displayed. This can allow the user to view each type of content at substantially the same time and make a decision which one to select for more information.

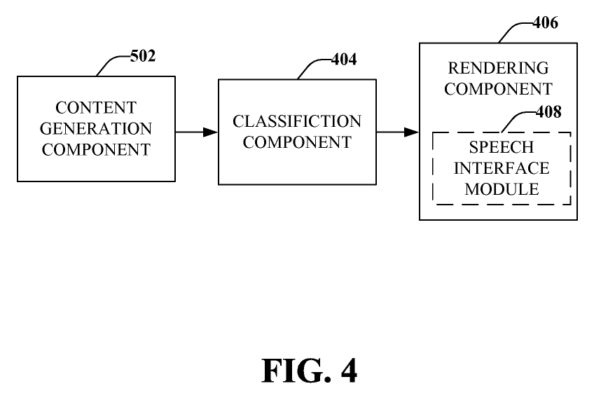

FIG. 4 illustrates a system 400 for providing multiple versions of a document and presenting one of the versions based on a rendering device. Sometimes content, such as a file or document, can be reviewed in detail. However, there may be situations when, based on device constraints, minimal content is desired (e.g., a high-level overview). System 400 can facilitate creating multiple versions of a document so that users of various devices can dynamically receive at least a sub-portion of the document.

System 400 includes a content generation component 402 that can be configured to create one or more versions of a document based on its relevant portions. A master version of the document can be maintained and the sub-portions or different versions can be retained within the single master version. Thus, if there are changes, only a single “master” version needs to be changed. In accordance with some aspects, a user can annotate a document and a later search can be performed on those annotations.

A classification component 404 can be configured to accept a categorization of various sections of a document (e.g., abstract, executive summary, contents, and so forth). The categories can be received from an author or other authorized entity or can be inferred autonomously by system 400. For example, a first section can be categorized as an executive summary and a second section, or sub-portions of a section, can be tagged as important or essential information. In accordance with some aspects, the essential information can be highlighted or presented in another manner so that attention can be focused on those sections. The essential information can be related to a search or other request received from a user. Rendering component 406 can display a heading of the relevant portions and, upon request, allows the user to drill down (e.g., though interaction with a navigation component) into the data to obtain more information.

For example, a twenty-page document might include a summary section. If a person using a mobile device, such as a cell phone, opens the document, system 400 could automatically present the summary, rather then the entire document. Thus, a synopsis of the content can be created and rendered as a function of the rendering device and/or a display size.

In accordance with some aspects, speech navigation is utilized in conjunction with tagging or annotations. A speech interface module 408 can be configured to dynamically present information imbedded in a communication, file and so forth. Speech interface module 408 can audibly present an entire file or document to a user. For example, an incoming communication might be received and automatically relayed by speech interface module 408. In accordance with some aspects, speech interface module 408 can review the imbedded information and determine that the content might be of interest to the user. For example, an email might be received with a phone number embedded in the email. Speech interface module 408 can recognize the content as a phone number and ask the user if the number should be called or another action performed (e.g., reply to the email, proceed to the next email and so forth). As such, a user can interact with system 400 in a “hands-off” manner through various speech or voice recognition means.

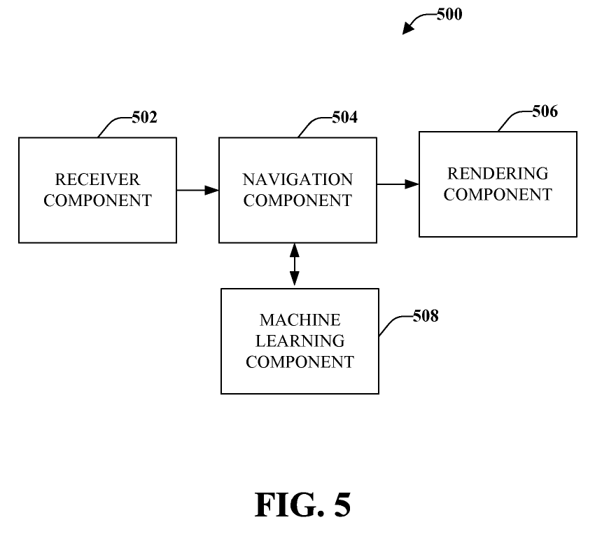

FIG. 5 illustrates an example system 500 that employs machine learning to automate one or more of the disclosed features. System 500 includes a receiver component 502 that can receive extrinsic evidence (e.g., user actions to determine a current role, location of a device, manual input, and so on) and/or a request for information or an action to be performed. A navigation component 504 can be configured to present (e.g., audibly, visibly) a high-level overview of various content that a user might like to receive and/or has requested. A rendering component 506 can present the information and as the user requests more or less data, navigation component 504 can dynamically route the user through available content.

System 500 can also include a machine learning component 508 that can employ various schemes (e.g., artificial intelligence, rules based logic) for carrying out various aspects. For example, a process for determining if a particular content should be presented to a user can be facilitated through an automatic classifier system and process. Such content can relate to important sections of a document, based on a received request or an annotation.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to access through a call, the type of data, the importance of the data, etc.

It will be appreciated that the a rules-based implementation can automatically and/or dynamically regulate presentation of information (e.g., mask or expose) based upon a predefined criterion. In response thereto, the rule-based implementation can grant and/or deny access by employing a predefined and/or programmed rule(s) based upon any desired criteria (e.g., role, action, time, and so forth).

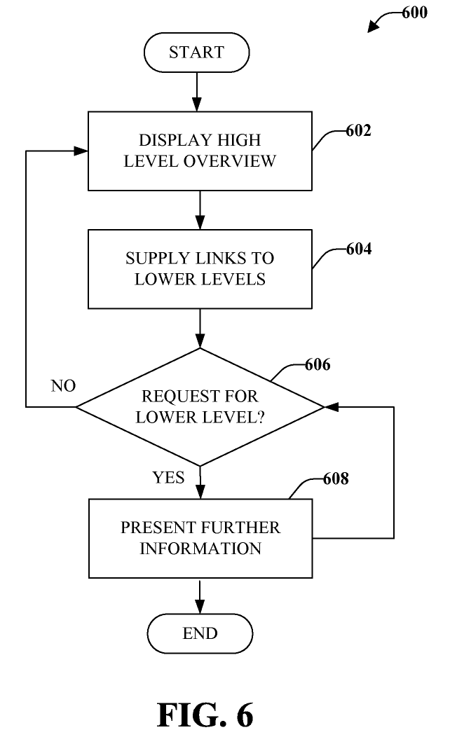

In view of the exemplary systems shown and described above, methodologies that may be implemented in accordance with the disclosed subject matter, will be better appreciated with reference to the flow charts of FIGS. 6-8. While, for purposes of simplicity of explanation, the methodologies are shown and described as a series of blocks, it is to be understood and appreciated that the disclosed aspects are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates a method 600 for providing navigation of display data on a user device. Method 600 can facilitate presenting a high-level overview of data and can selectively present more detailed information as requested by a user. Method 600 starts, at 602, when a high-level overview of data is presented. The high-level overview can be presented as icons or in other formats so that a user can quickly look at a display area and perceive the content. Embedded within the icons or other representations of the high-level overview are links to lower levels of content, which might be structured in a hierarchy, whereby each level down or lower in the hierarchy can present more information.

At 608 a determination is made whether a request for a lower level in the hierarchy is received. If a request is not received (“NO”), the method continues at 602, with presentation of the high level overview. If a request is received (“YES”), the user is dynamically presented with more information, which can be more detailed information. The information can be dynamically rendered as a function of the display area of the rendering device.

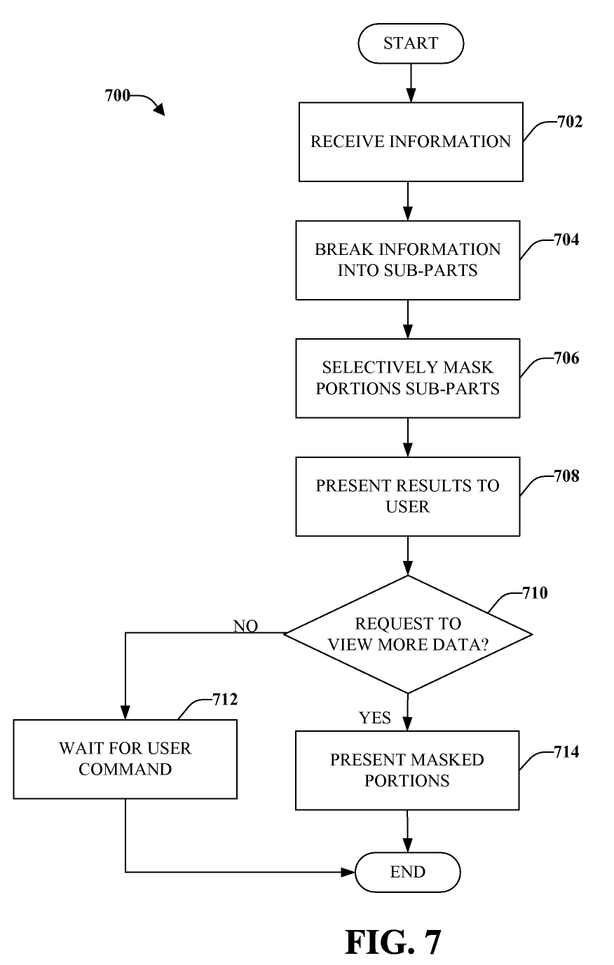

FIG. 7 illustrates a method 700 for selectively presenting a subset of data to a user. Many mobile devices have small display areas making rendering of large amount of content difficult. Information and various portions of the information can be presented in the form of lists, however, such lists can grow quite large and can be difficult to navigate. Therefore, method 700 can provide a user with metadata that exposes a user to meaningful information.

Method 700 starts, at 702, when information is received. The information can be obtained internally on a device or from an external source or might be an incoming message. At substantially the same time as the information is received, it can be divided or broken into sub-parts, at 704. The sub-parts can include portions of a document that are logically divided (e.g., paragraphs, pages, chapters), wherein the sub-parts are divided as a function of a display space. Each sub-portion can be associated with a heading or tag and a user can select the heading or tag to obtain further, more in depth information.

At 706, portions of the content are selectively masked. For example, portions of the document that are not considered relevant to the user can be hidden from view to mitigate clutter on a display area. In accordance with some aspects, information relating to a heading or tag is masked, allowing for viewing of additional heading or tags, at 708.

At 710, it is determined whether a request to view more information was received. The request can be made by a user selecting a heading or a tag (e.g., highlighting and pressing enter, clicking with a mouse, voice activation and so forth). If a request was not received (“NO”), method 700 can continue, at 712, until a next command is received. The next command can include retrieving different data or performing another function.

If the determination at 710 is that a request was received (“YES”), one or more masked portions can be presented to the user, at 714. The masked portions might represent further detail about a heading or tag. The masked portions might also relate to further information (e.g., more information on a page of data).

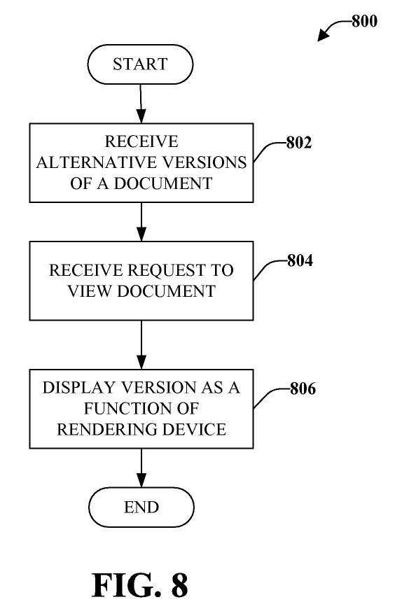

FIG. 8 illustrates a method 800 for dynamically displaying a version of a document as a function of a rendering device. Mobile devices generally have a small screen or display area and documents or other data displayed on the device can be difficult to navigate. Method 800 can allow an author or another authorized entity to submit multiple versions of a document, at 802. The versions can relate to a full version of a document and one or more alternate versions that contain subsets of the full version. At 804, a request to receive the document is received. The request can be from a user of a mobile device.

At 806, a version of the document is presented in reply to the request, wherein the version is a function of a rendering device. For example, if the request is from a desktop computer, with a full screen, the full version of the document can be presented. However, if the request is from a device, such as a mobile phone, a scaled down version of the document can be rendered to correspond with a display area of the mobile phone.

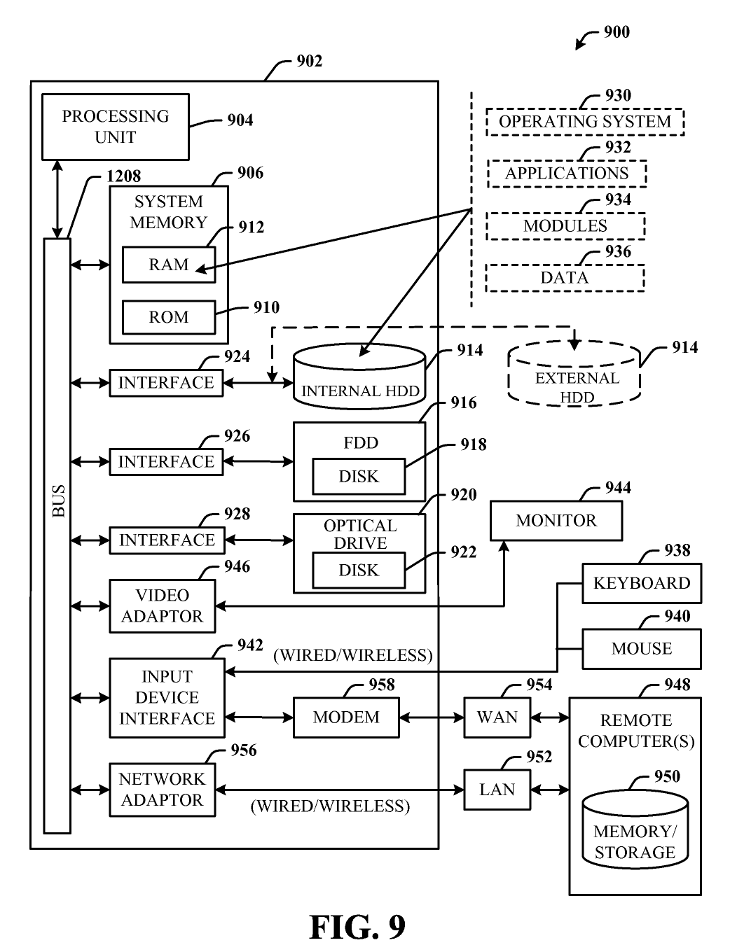

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various aspects can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

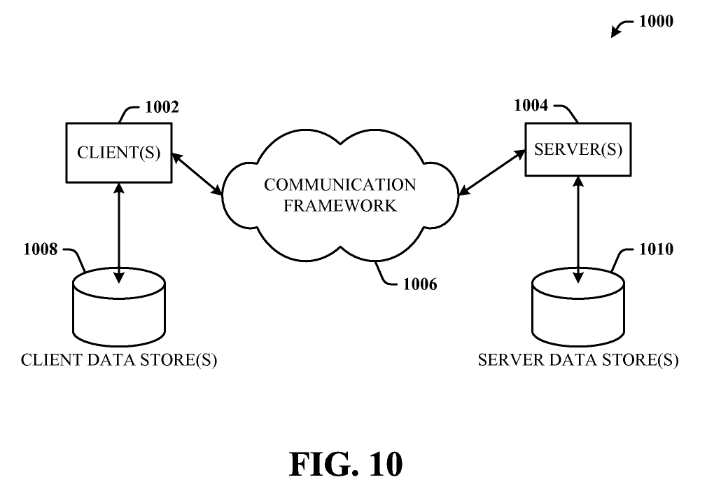

Referring now to FIG. 10, there is illustrated a schematic block diagram of an exemplary computing environment 1000 in accordance with the various aspects. The system 1000 includes one or more client(s) 1002. The client(s) 1002 can be hardware and/or software (e.g., threads, processes, computing devices). The client(s) 1002 can house cookie(s) and/or associated contextual information by employing the various aspects, for example.

The system 1000 also includes one or more server(s) 1004. The server(s) 1004 can also be hardware and/or software (e.g., threads, processes, computing devices). The servers 1004 can house threads to perform transformations by employing the various aspects, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates navigation on a user device, comprising:
a receiver component that receives a request for information;
a navigation component that directs a user from a high-level overview of the information to full details of the information; and
a rendering component that present a subset of the detailed information as a function of a rendering device.

2. The system of claim 1, the navigation component transitions from the high-level overview to the full details based on a user request.

3. The system of claim 1, the navigation component transitions from the full details to the high-level overview based on a user request

4. The system of claim 1, further comprises a relevance component that analyzes content and determines a significance of the content to a user.

5. The system of claim 4, further comprises a role selection module that provides a user with a selection based on a role in which the user is functioning.

6. The system of claim 4, further comprises an observation component that selectively determines a user role based on a current time.

7. The system of claim 4, further comprises an observation component that infers a role based on extrinsic evidence.

8. The system of claim 1, further comprising:
a content generation component that creates at least two versions of a document; and
a classification component that categorizes various sections of the document, the rendering component displays one of the at least two versions of the document as a function of a rendering device.

9. The system of claim 8, the content generation component maintains a master version of the document and one or more different versions of the document.

10. The system of claim 1, further comprising:
a search module that automatically performs a search for data based on a user request; and
a verification module that confirms if discovered data matches the requested data.

11. The system of claim 10, the verification module presents two or more alternatives to the discovered data.

12. The system of claim 1, further comprises a resize module that reconfigures at least one subset of the detailed information based on a screen size.

13. The system of claim 1, further comprises a partition module that subdivides a display area to present the subsets of the detailed information in different areas of the display.

14. The system of claim 1, further comprises a machine learning component that automates one or more system components.

15. A method for selectively presenting a subset of data to a user, comprising:
displaying a high level overview of requested content;
presenting links to lower level content;
receiving a request to transition from the high level overview to the lower level content; and
selectively presenting the lower level content as a function of a rendering device.

16. The method of claim 15, further comprising:
masking portions of the lower level content; and
exposing the lower level content when the request is received.

17. The method of claim 15, further comprising:
receiving at least two alternative versions of a document; and
selecting one of the at least two alternative versions to present as lower level content.

18. The method of claim 15, further comprising:
receiving a request to expose the high level overview; and
selectively masking the low level content.

19. A computer-implemented system for providing semantic navigation on a user device, comprising:
means for receiving a request to view content;
means for presenting the content as a function of a user device; and
means for selectively masking or exposing content based on a user request, a user role, or combinations thereof.

20. The system of claim 19, further comprises means for displaying at least one version of a document as a function of the rendering device.
